(19) United States
(12) Patent Application Publication
(10) Pub. No.: US 2004/0117047 A1
(43) Pub. Date: Jun. 17, 2004

(54) Creation method for a workflow which is to be processed by a processor

(76) Inventors: Thomas Birkholzer, Radolfzell (DE); Jurgen Vaupel, Weisendorf (DE)

Correspondence Address: HARNESS, DICKEY & PIERCE, P.L.C., P.O.BOX 8910, RESTON, VA, 20195, US

(21) Appl. No.: 10/640,254

(22) Filed: Aug. 14, 2003

(30) Foreign Application Priority Data
Aug. 14, 2002 (DE) 10237349.3

(51) Int. Cl. G06F 19/00

(52) U.S. Cl. 700/100

(57) ABSTRACT

A processor receives from an operator, specific parameters for an object and also a succession of control commands for test and/or control measures which are to be performed on the object. The processor performs the measures on the object. The processor stores the succession of control commands as a workflow and outputs selected instances of the parameters to the operator using an output medium. The processor receives generalizations for the selected parameters from the operator and stores the generalizations as a selection criterion for the workflow.

The present application hereby claims priority under 35 U.S.C. §119 on German patent application number DE 10237349.3 filed Aug. 14, 2002, the entire contents of which are hereby incorporated herein by reference.

### FIELD OF THE INVENTION

The present invention generally relates to a creation method for a workflow which is to be processed by a processor, a computer readable medium and the processor. Such workflows are used in the medical sector, inter alia.

### BACKGROUND OF THE INVENTION

Particularly in the medical sector, automated workflow support is a fundamental tool for increasing efficiency in imaging. In this case, the workflows can be considered at the level of the workstation (e.g. of the “modality”), of the department (e.g. of radiology or ultrasound) or of the entire medical complex (e.g. of the hospital).

To automate workflows, the prior art uses “workflow engines”, i.e. flow controllers which allocate orders to clients, e.g. in the form of work lists. However, these workflow engines require that the desired flows be in machine-readable form. This gives rise to the problem of efficiently creating these flow definitions. This is because the experts for the flows, e.g. the physicians or the medico-technical X-ray assistants, are normally not computer specialists. They thus have no or little experience in describing a flow in machine-readable form.

In the prior art, machine-readable flow definitions are therefore usually produced by computer specialists, that is to say by computer scientists or programmers who analyze a workflow through observation and then put it into computer-readable form. Alternatively, attempts are also made to provide the actual users of the processor with graphical tools which are intended to allow intuitive input. Despite the graphical support, however, these tools can be used by the users only with difficulty. Automated workflows have therefore been introduced only to a small extent.

### SUMMARY OF THE INVENTION

An object of an embodiment of the present invention is to provide a creation method for a workflow which is to be processed by a processor, a computer readable medium and the processor itself. The creation method can also preferably be used by persons who are not computer specialists to create such a workflow in a simple manner.

An object may be achieved by at least one of the following steps to be executed by the processor:

the processor receives specific parameters for an object from an operator,

the processor receives from the operator a succession of control commands for test and control measures which are to be performed on the object and performs them on the object,

the processor stores the succession of control commands as a workflow,

the processor outputs selected instances of the parameters to the operator using an output medium,

the processor receives generalizations for the selected parameters from the operator,

the processor stores the generalizations as a selection criterion for the workflow.

Specifically, this allows the workflow—for a specific object at first—to be input into the processor in a similar manner to a teach-in. The learning process for the processor is thus very simple. The generalizations prompted by the operator can then easily be used to create a workflow for object classes defined by the generalizations.

It is possible for the selective parameters initially to include all the received parameters. This is not necessary, however. This is because particularly the parameters which individualize the object directly are not needed for creating the selection criterion. Preferably, the selected parameters therefore include all the received parameters with the exception of parameters which individualize the object directly. Alternatively or in addition, it is also possible for the processor to be told by the operator which of the parameters have been selected.

It is possible to generalize the parameters such that the generalization represents a generic term for the specific parameter. By way of example, existing health insurance can be typified. The generalization can also assume a value range, e.g. an age range between 10 and 14 years. In specific cases, the generalization can even go so far (for an individual parameter or for individual instances of the parameters) as for the selection criterion to be independent of the respective parameter. The examination of a broken leg, by way of example, is independent of a patient's sex and essentially also age.

If the succession of control commands is also output to the operator using the output medium, the creation method can be carried out in an even better manner. If this involves the succession of control commands being output graphically, the significance of the control commands is usually easier for the operator to grasp.

If the succession of control commands is output together with the output of selected parameters, it is a particularly simple matter for the operator to create the selection criterion.

If the succession of control commands which is stored as a workflow is changed on the basis of corresponding inputs from the operator, the creation method is even more flexible. In particular, the workflow can also be adapted as such in this case.

The test and/or control measures are typically medical measures, particularly therapeutic or diagnostic measures.

### BRIEF DESCRIPTION OF THE DRAWINGS

Other advantages and details can be found in the description below of an exemplary embodiment in conjunction with the drawings, in which, in basic illustration,

FIG. 1 schematically shows a processor and its peripheral area,

FIG. 2 shows a flowchart,

FIG. 3 shows a monitor display,

FIGS. 4 and 5 show windows in the monitor display from FIG. 3, and

FIGS. 6 and 7 schematically show a succession of control commands together with associated object parameters before and after the generalizations have been implemented.

### DETAILED DESCRIPTION OF THE PREFERRED EMBODIMENTS

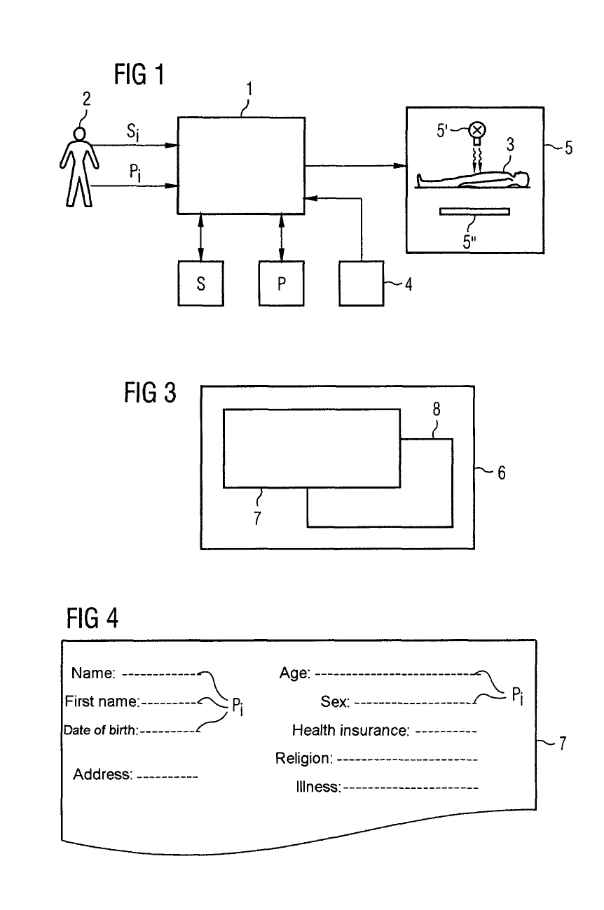

In line with FIG. 1, a processor 1 receives specific parameters Pᵢ for a specific object 3 from an operator 2 during specific handling (in the widest sense) of the object 3. The object 3 is a person in the present case. Alternatively, the object 3 could be an animal or a workpiece which is to be machined.

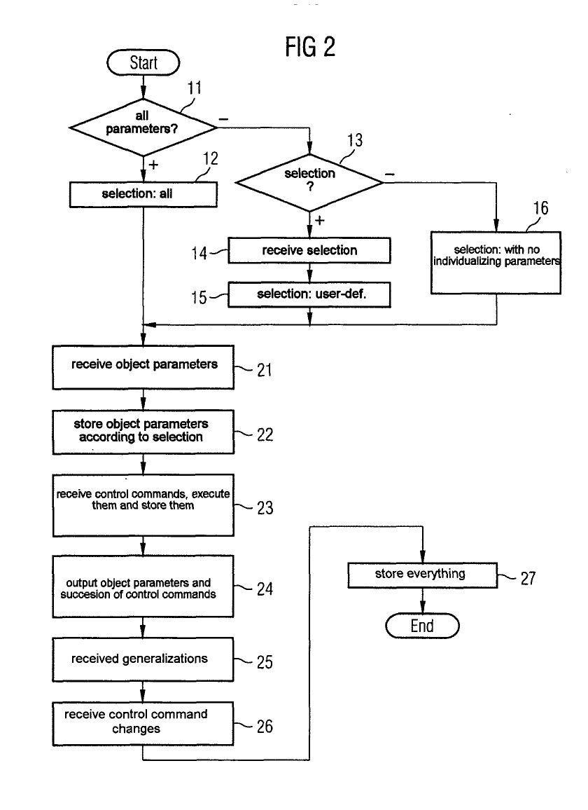

The operation of the processor 1 is controlled by a computer program 4 with which the processor 1 has been programmed. During control by the computer program 4, the processor 1 carries out a creation method which is described in more detail below in conjunction with FIG. 2.

In line with FIG. 2, the processor 1 first receives the parameters Pᵢ in a step 21. In a step 22, it then stores the object parameters Pᵢ in a parameter file P on the basis of a selection. The selection will be discussed in more detail at a later point.

In addition, the processor 1 receives a succession of control commands Sᵢ in a step 23—preferably after the parameters Pᵢ have been received. In this case, the control commands Sᵢ are likewise prescribed to the processor 1 by the operator 2. The processor 1 stores the control commands Sᵢ as a workflow S in a control command file S.

The control commands Sᵢ define test and/or control measures which are to be performed on the object 3. The processor 1 therefore actuates a device 5, in this case an X-ray installation (shown schematically), during step 23 and thus executes the control commands Sᵢ on the object 3.

In line with FIG. 1, the device 5 is an X-ray device 5. It therefore has, in particular, an X-ray source 5′ and an X-ray detector 5″. Typically, such X-ray devices 5 are used to perform diagnostic medical measures. In specific cases, the X-ray device 5 can alternatively be used to perform therapeutic measures, e.g. for fighting tumours.

Alternatively, the device 5 can be another device used for performing therapeutic measures, e.g. a shockwave lithotripter or a metering device for an injectable drug.

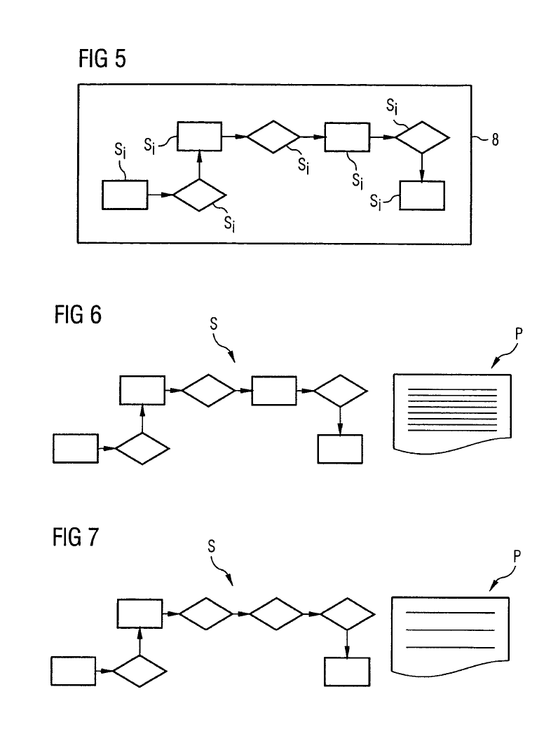

When the input—and also the execution—of the control commands Sᵢ is complete, the processor 1 outputs the selected parameters Pᵢ stored in the parameter file P and also the succession of control commands Sᵢ which is stored in the control command file S to the operator 2 using an output medium 6 in a step 24. In line with FIG. 3, the output medium 6 can be a monitor 6, for example, which is used to display the selected parameters Pᵢ in a window 7 and the succession of control commands Sᵢ in another window 8. In line with FIG. 3, both the selective parameters Pᵢ and the succession of control commands Sᵢ are thus output to the operator 2 using the same output medium 6 and simultaneously. The succession of control commands Sᵢ is thus output together with the selected parameters Pᵢ in line with FIG. 6. As FIG. 5 also shows, the succession of control commands Sᵢ is output in the window 8 graphically.

The parameters Pᵢ can be of diverse nature. As can be seen from FIG. 4, they can include, in particular, the name, the first name, the date of birth, the address, the age, the sex, the health insurance of the person 3 and also other details. The other details can comprise, for example in schematic form, an examination order, preliminary examinations or else a referring institution, for example.

In a highly schematic illustration, FIG. 6 now shows the succession of control commands Sᵢ and the selected parameter Pᵢ initially stored in the parameter file P next to one another. To obtain a succession of control commands Sᵢ which can be used as a workflow S beyond specific instances, these parameters Pᵢ now need to be generalized. The processor 1 therefore receives generalizations for the selected parameters Pᵢ stored in the parameter file P from the operator 2 in a step 25. The processor 1 naturally also makes these changes. In this context, in specific cases, the generalizations can go so far as for the selection criterion defined by the generalizations to be completely independent of at least one of the parameters Pᵢ. The generalizations are stored by the processor 1 as a selection criterion P for the workflow S.

In addition, the processor 1 may also receive inputs from the operator 2 for changes to the control commands Sᵢ in a step 26. The succession of control commands Sᵢ is then changed by the processor 1 on the basis of the inputs. The changed succession of control commands Sᵢ which is now present is stored by the processor 1 as a new workflow S. Both files P, S are stored in a step 27 in line with FIG. 2.

What is obtained, as shown schematically in FIG. 7 and can be seen by comparison with FIG. 6, is thus a changed succession of control commands Sᵢ which normally has a considerably simplified or generalized associated set of selected parameters Pᵢ. This is shown schematically in FIG. 7.

When specific parameters Pᵢ for another object are subsequently prescribed, the processor 1 is therefore able to use the stored selection criterion (=parameter file P) to decide whether the corresponding workflow S needs to be executed. The processor 1 is therefore capable of at least proposing this workflow S autonomously, and possibly of even executing it fully or semi-automatically.

During specific use of the device 5 for a specific object 3, it is naturally necessary to input not just typical specific parameters Pᵢ, but also individualizing specific parameters Pᵢ. Examples which may be mentioned here are again the parameters listed in connection with FIG. 4. During creation of a workflow S which is to be processed by the processor 1, on the other hand, precisely these individualizing specific parameters Pᵢ are of no consequence. This is because this does not involve the creation of a specific workflow for the specific object 3, but rather the creation of a workflow S which can be used a plurality of times. Before step 21, the processor 1 therefore executes steps 11-16 in line with FIG. 2.

In step 11, the processor 1 asks the operator 2 whether all the parameters Pᵢ which have been input need to be stored in the parameter file P. If this is the case, the processor 1 sets the selection made to “all” in a step 12.

If not all the parameters Pᵢ need to be stored in the parameter file P, then in step 13 the processor 1 asks the operator 2 whether he wishes to prescribe which of the parameters Pᵢ need to be stored in the parameter file P. If the operator 2 chooses this option, the processor 1 receives the selected parameters Pᵢ in a step 14 and sets the selection to “user-defined” in step 15.

If neither all of the parameters Pᵢ nor a user-defined selection need to be stored in the parameter file P, the processor 1 sets the selection to all parameters Pᵢ with the exception of parameters Pᵢ which individualize the object 3 in step 16. These parameters Pᵢ are the name, the first name, the date of birth and the address of the person 3, in particular.

An embodiment of the inventive creation method may thus be based on the basic principle of, in a similar manner to a teach-in, initially detecting a specific circumstance, namely the parameters Pᵢ, and a specific succession of control commands Sᵢ and then generating a more generally usable workflow S in addition to a corresponding selection criterion P by manually processing the parameters Pᵢ, in particular. It may thus be based on the fundamental insight that it is much easier for staff who have no computer training to alter and optimize an existing data record (succession of control commands Sᵢ in addition to associated set of selected parameters Pᵢ) than to create a workflow S in addition to an associated selection criterion P from scratch themselves.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A creation method for a workflow to be processed by a processor, comprising:
receiving parameters for an object from an operator;
receiving, from the operator, a succession of control commands for at least one of test and control measures to be performed on the object and performing the control commands on the object;
storing the succession of control commands as a workflow;
outputting selected instances of the parameters to the operator;
receiving generalizations for the selected parameters from the operator; and
storing the generalizations as a selection criterion for the workflow.

2. The creation method as claimed in claim 1, wherein the selected parameters include all the received parameters.

3. The creation method as claimed in claim 1, wherein the selected parameters include all the received parameters with the exception of parameters which individualize the object directly.

4. The creation method as claimed in claim 1, wherein the operator conveys to the processor, which of the parameters have been selected.

5. The creation method as claimed in claim 1, wherein the selection criterion is independent of at least one of the parameters.

6. The creation method as claimed in claim 1, wherein the succession of control commands stored as a workflow, is also output to the operator using an output medium.

7. The creation method as claimed in claim 6, wherein the succession of control commands, stored as a workflow, is output graphically.

8. The creation method as claimed in claim 6, wherein the succession of control commands, stored as a workflow, is output together with the output of the selected parameters.

9. The creation method as claimed in claim 6, wherein the succession of control commands, stored as a workflow, is changed on the basis of corresponding inputs from the operator.

10. The creation method as claimed in claim 1, wherein at least one of the test and control measures are medical measures.

11. A computer program for causing the processor to carry out a creation method as claimed in claim 1.

12. A processor programmed with a computer program as claimed in claim 11.

13. The creation method as claimed in claim 3, wherein the operator conveys to the processor, which of the parameters have been selected.

14. The creation method as claimed in claim 2, wherein the succession of control commands stored as a workflow, is also output to the operator using an output medium.

15. The creation method as claimed in claim 14, wherein the succession of control commands, stored as a workflow, is output graphically.

16. The creation method as claimed in claim 3, wherein the succession of control commands stored as a workflow, is also output to the operator using an output medium.

17. The creation method as claimed in claim 16, wherein the succession of control commands, stored as a workflow, is output graphically.

18. The creation method as claimed in claim 1, wherein at least one of the test and control measures are at least one of therapeutic and diagnostic measures.

19. The creation method as claimed in claim 2, wherein at least one of the test and control measures are medical measures.

20. The creation method as claimed in claim 3, wherein at least one of the test and control measures are medical measures.

21. A computer-readable medium comprising a computer program configured to cause a processor to perform the method of claim 1.

22. A computer program for causing the processor to carry out a creation method as claimed in claim 2.

23. A processor programmed with a computer program as claimed in claim 22.

24. A computer-readable medium comprising a computer program configured to cause a processor to perform the method of claim 2.

25. A computer program for causing the processor to carry out a creation method as claimed in claim 3.

26. A processor programmed with a computer program as claimed in claim 25.

27. A computer-readable medium comprising a computer program configured to cause a processor to perform the method of claim 3.

28. The creation method as claimed in claim 1, wherein selected instances of the parameters are output to the operator using an output medium.

29. A processor, comprising:
means for receiving, from an operator, a succession of control commands for at least one of test and control measures to be performed on the object;
means for performing the control commands on the object;
means for storing the succession of control commands as a workflow; and
means for outputting selected instances of the parameters to the operator, wherein the means for receiving is further for receiving generalizations for the selected parameters from the operator and wherein the means for storing is further for storing the generalizations as a selection criterion for the workflow.

30. The processor as claimed in claim 29, wherein the selected parameters include all the received parameters.

31. The processor as claimed in claim 29, wherein the selected parameters include all the received parameters with the exception of parameters which individualize the object directly.

32. A creation method for a workflow to be processed by a processor, comprising:
receiving parameters for an object;
receiving a succession of control commands for at least one of test and control measures to be performed on the object and performing the control commands on the object;
storing the succession of control commands as a workflow;
outputting selected instances of the parameters;
receiving generalizations for the selected parameters; and
storing the generalizations as a selection criterion for the workflow.

33. The creation method as claimed in claim 32, wherein the selected parameters include all the received parameters.

34. The creation method as claimed in claim 32, wherein the selected parameters include all the received parameters with the exception of parameters which individualize the object directly.

35. A computer program for causing the processor to carry out a creation method as claimed in claim 32.

36. A processor programmed with a computer program as claimed in claim 32.

37. A computer-readable medium comprising a computer program configured to cause a processor to perform the method of claim 32.

38. A processor, comprising:
means for receiving a succession of control commands for at least one of test and control measures to be performed on the object;
means for performing the control commands on the object;
means for storing the succession of control commands as a workflow; and
means for outputting selected instances of the parameters, wherein the means for receiving is further for receiving generalizations for the selected parameters and wherein the means for storing is further for storing the generalizations as a selection criterion for the workflow.

39. The processor as claimed in claim 38, wherein the selected parameters include all the received parameters.

40. The processor as claimed in claim 38, wherein the selected parameters include all the received parameters with the exception of parameters which individualize the object directly.
